(19) United States
(12) Patent Application Publication
(10) Pub. No.: US 2018/0088671 A1
(43) Pub. Date: Mar. 29, 2018

(54) 3D Hand Gesture Image Recognition Method and System Thereof

(71) Applicant: National Kaohsiung University of Applied Sciences, Kaohsiung (TW)

(72) Inventor: Jing-Wein Wang, Kaohsiung (TW)

(21) Appl. No.: 15/277,013

(22) Filed: Sep. 27, 2016

(51) Int. Cl. G06F 3/01; G06F 3/00; G06T 7/40

(52) U.S. Cl. CPC G06F 3/017; G06T 2207/10024; G06T 7/408; G06F 3/005

(57) ABSTRACT

A 3D hand gesture recognition system includes a light field capturing unit, a calculation unit and an output unit. The light field capturing unit is provided to capture a hand gesture action to obtain a 3D hand gesture image. The calculation unit connects with the light field capturing unit and is provided to project the 3D hand gesture image to a predetermined space to obtain eigenvectors which are compared with the samples to classify and recognize a signal of the 3D hand gesture image. The output unit connects with the calculation unit to output the signal of the 3D hand gesture image to a predetermined device.

### BACKGROUND OF THE INVENTION

### 1. Field of the Invention

The present invention relates to a 3D hand gesture image recognition method and system thereof. Particularly, the present invention relates to the 3D hand gesture image recognition method and system thereof with at least one or a plurality of light field capturing units.

### 2. Description of the Related Art

Taiwanese Patent Publication No. M382675, entitled “Hand Gesture Recognition-based Monitoring Camera Control Device,” discloses a control device for outputting commands to turn left, right, upward or downward and to zoom in or out to operate a monitoring camera. A hand gesture-capturing camera is provided to recognize a hand gesture of users for turning left, right, upward or downward and zooming in or out, without the need of operating a mouse or a control lever.

Another Taiwanese Patent Publication No. I298461, entitled “Hand Gesture Recognition System and Method Thereof,” discloses a hand gesture recognition system. A laptop computer includes an image-capturing device with which to directly capture a predetermined hand gesture of a user for conveniently executing an associated application program or an option of functions stored in the laptop computer.

Another Taiwanese Patent Publication No. I395145, entitled “Hand Gesture Recognition System and Method Thereof,” discloses a hand gesture recognition system. The hand gesture recognition system includes a camera device provided to take an image of nature hand gestures, a processor provided to retrieve edges of skin portions from the image and to thereby classify the edges into edge pieces in different degrees, a calculator engine with parallel computing units (PCUs) and predetermined templates of hand gesture database with different degrees provided to search the templates most similar to the edge pieces, means for selecting an optimum template among the most similar templates with the PCUs, and a display terminal provided to display an image of the selected optimum template without using any marker.

Another Taiwanese Patent Publication No. I431538, entitled “Image Based Motion Gesture Recognition Method and System Thereof,” discloses a hand gesture recognition method which includes: receiving a plurality of hand image frames; executing first hand posture detection in the received image frames to obtain a first hand posture; determining the first hand posture to match a predetermined start posture or not; executing hand movement tracking with hand locations in the received image frames to obtain a hand motion gesture if the first hand posture is matched; during the hand movement tracking, further executing second hand posture detection in the received image frames to obtain a second hand posture and terminating the hand movement tracking if the second hand posture matches a predetermined end posture.

Another Taiwanese Patent Publication No. I444907, entitled “Method of Using Singular Value Decomposition for Processing Hand Gesture Images with Complex Background and a System Thereof” discloses a hand gesture image processing method and a system thereof. The method of using singular value decomposition for processing hand gesture images with complex background includes: decomposing an original image in a singular value decomposition manner to obtain an enhanced image; removing dark background from the enhanced image to obtain a skin-like region; removing residual background from the skin-like region. The hand gesture image processing system includes an input unit provided to input the original image, a calculating unit provided to remove dark background from the enhanced image and an output unit provided to output a skin color image.

Another Taiwanese Patent Publication No. I1444908, entitled “Hand Gesture Image Recognition Method and System Using Image Orientation Alignment,” discloses a hand gesture image alignment method and a system thereof. A hand gesture image alignment method includes: decomposing a skin color image in a singular value decomposition manner to obtain an enhanced image; calculating a global centroid in the skin color image; selecting a region of interest (ROI) in the skin color image; selecting a sub-region in the ROI; calculating a local centroid in the sub-region; calculating an alignment angle. The hand gesture image alignment system includes an input unit provided to input the skin color image, a calculating unit provided to select the ROI and the sub-region to calculate the global centroid and the local centroid, thereby calculating the alignment angle, and an output unit provided to output the alignment angle.

Another Taiwanese Patent Publication No. I444909, entitled “Hand Gesture Image Recognition Method and System Using Singular Value Decomposition for Light Compensation,” discloses a hand gesture image compensation method and a system thereof. A hand gesture image recognition method using singular value decomposition for light compensation includes: inputting a hand gesture image; processing the hand gesture image by singular value decomposition; calculating a light compensation coefficient by a light compensation method; compensating light on the hand gesture image by the light compensation coefficient to obtain a light-compensated image. The hand gesture image compensation system includes an input unit provided to input the original image, a calculating unit provided to calculate the light compensation coefficient, thereby processing the image to obtain the light-compensated image, and an output unit provided to output the light-compensated image.

Another U.S. Pat. No. 7,702,130, entitled “User Interface Apparatus Using Hand Gesture Recognition and Method Thereof,” discloses a user interface apparatus and method thereof. The user interface apparatus can control a telematics terminal safely and comfortably while driving, by recognizing a hand gesture image received through a camera in the telematics terminal as a corresponding control signal. The user interface apparatus includes: an input receiving block for receiving a command registration request signal and a command selection signal; a hand gesture recognizing block for storing the hand gesture image in connection with a specific command, and transforming the hand gesture image into the corresponding command by recognizing the hand gesture image from the image obtained in the image obtaining block; and a command performing block for performing an operation corresponding to a command transformed in the hand gesture recognizing block.

Another U.S. Pat. No. 7,680,295, entitled “Hand-gesture Based Interface Apparatus,” discloses a hand-gesture based interface apparatus. The interface is provided that corresponds to an individual person without being restricted to a particular place within a room, by performing gesture recognition while identifying an individual person. A stereo camera picks up an image of a user, and based on the image pickup output, an image processor transmits a color image within a visual field and a distance image to an information integrated recognition device. The information integrated recognition device identifies an individual by the face of the user, senses the position, and recognizes a significant gesture based on a hand sign of the user. The information integrated recognition device executes a command corresponding the identified user and performs operations of all devices to be operated in the room (such as a TV set, an air conditioner, an electric fan, illumination, acoustic condition, and window opening/closing).

Another U.S. Pat. No. 6,215,890, entitled “Hand Gesture Recognizing Device,” discloses a hand gesture recognizing device. The hand gesture recognizing device can correctly recognize hand gestures at high speed without requiring users to be equipped with tools. A gesture of a user is stereoscopically filmed by a photographing device and then stored in an image storage device. A feature image extracting device transforms colors of the stereoscopic image data read from the image storage device in accordance with color transformation tables created by a color transformation table creating device, and disassembles and outputs the feature image of the user in corresponding channels. A spatial position calculating device calculates spatial positions of feature parts of the user by utilizing parallax of the feature image outputted from the feature image extracting device. A region dividing device defines the space around the user with spatial region codes. A hand gesture detecting device detects how the hands of the user move in relation to the spatial region codes. A category is detected first on the basis of the detected hand gesture, and then a sign language word in that category is specified.

Another U.S. Pat. No. 6,002,808, entitled “Hand Gesture Control System,” discloses a hand gesture control system. The system is provided for rapidly recognizing hand gestures for the control of computer graphics, in which image moment calculations are utilized to determine an overall equivalent rectangle corresponding to hand position, orientation and size, with size in one embodiment correlating to the width of the hand. In a further example, a hole generated through the utilization of the touching of the forefinger with the thumb provides a special trigger gesture recognized through the corresponding hole in the binary representation of the hand. In a further example, image moments of images of other objects are detected for controlling or directing onscreen images.

Another U.S. Pat. No. 5,594,469, entitled “Hand Gesture Machine Control System,” discloses a hand gesture machine control system. A system for the control from a distance of machines having displays includes hand gesture detection in which the hand gesture causes movement of an on-screen hand icon over an on-screen machine control icon, with the hand icon moving the machine control icon in accordance with sensed hand movements to effectuate machine control. In an example, TV control led by hand signals includes detecting a single hand gesture and providing a hand icon on the screen along with the provision of icons representing TV controls such as volume, channel, color, density, etc., in which a television camera detects the hand in a noisy background through correlation techniques based on values of local image orientation. In order to trigger the system into operation, a trigger gesture such as the “how” sign is distinguished from the background through the utilization of orientation angle differences. From correlation values based on correlating local orientations between a mask defining a particular hand and the later acquired image of the hand, normalized correlation scores for each pixel are obtained, with the correlation peak being detected and then thresholded to eliminate false alarms.

However, there is a need of improving the conventional hand gesture image recognition method and system for accurately recognizing hand gestures. The above-mentioned patent and patent application publications are incorporated herein by reference for purposes including, but not limited to, indicating the background of the present invention and illustrating the situation of the art.

As is described in greater detail below, the present invention provides a 3D hand gesture image recognition method and system thereof. A light field capturing unit is operated to capture a hand gesture action to thereby obtain at least one 3D hand gesture image. The 3D hand gesture image is projected to a predetermined space to obtain at least one set of eigenvectors which are compared with a plurality of samples to classify and recognize a signal of the 3D hand gesture image in such a way as to improve the reliability of conventional hand gesture image recognition methods.

### SUMMARY OF THE INVENTION

The primary objective of this invention is to provide a 3D hand gesture image recognition method and system thereof. A light field capturing unit is operated to capture a hand gesture action to thereby obtain at least one 3D hand gesture image. The 3D hand gesture image is projected to a predetermined space to obtain at least one set of eigenvectors which are compared with a plurality of samples to classify and recognize a signal of the 3D hand gesture image. Advantageously, the 3D hand gesture image recognition system and method of the present invention is successful in enhancing the reliability of hand gesture image recognition and increasing recognition rates.

The 3D hand gesture image recognition method in accordance with an aspect of the present invention includes:

operating a light field capturing unit to capture a hand gesture action to thereby obtain at least one 3D hand gesture image;

projecting the at least one 3D hand gesture image to a predetermined space to obtain at least one set of eigenvectors; and

comparing the eigenvectors with a plurality of samples to classify and recognize a signal of the 3D hand gesture image.

In a separate aspect of the present invention, the 3D hand gesture image includes 2D plane information and depth information.

In a further separate aspect of the present invention, the 3D hand gesture image is a 3D contour image, a 3D solid RGB image or combination thereof.

In yet a further separate aspect of the present invention, the 3D solid RGB image is further projected to the predetermined space by a projection color space method, thereby obtaining R channel image information, G channel image information and B channel image information.

In yet a further separate aspect of the present invention, the 3D hand gesture image is projected to the predetermined space by principal component analysis.

In yet a further separate aspect of the present invention, the eigenvectors are compared with the plurality of samples by a k-nearest neighbor method to classify and recognize the signal of the 3D hand gesture image.

The 3D hand gesture image recognition method in accordance with an aspect of the present invention includes:

operating a light field capturing unit to capture a series of hand gesture actions to thereby obtain a first 3D hand gesture image and a second 3D hand gesture image;

projecting the first 3D hand gesture image and the second 3D hand gesture image to a predetermined space to obtain a first set of first eigenvectors and a second set of second eigenvectors;

comparing the first eigenvectors and the second eigenvectors with a plurality of samples to classify and recognize a first signal of the first 3D hand gesture image and a second signal of the second 3D hand gesture image; and

identifying the second signal of the second 3D hand gesture image with the first signal of the first 3D hand gesture image.

In a separate aspect of the present invention, the first 3D hand gesture image and the second 3D hand gesture image include 2D plane information and depth information.

In a further separate aspect of the present invention, the first 3D hand gesture image and the second 3D hand gesture image are 3D contour images, 3D solid RGB images or combination thereof.

In yet a further separate aspect of the present invention, the 3D solid RGB image is further projected to the predetermined space by a projection color space method, thereby obtaining R channel image information, G channel image information and B channel image information.

In yet a further separate aspect of the present invention, the first 3D hand gesture image and the second 3D hand gesture image are projected to the predetermined space by principal component analysis.

In yet a further separate aspect of the present invention, the first eigenvectors and the second eigenvectors are compared with the plurality of samples by a k-nearest neighbor method to classify and recognize the signal of the 3D hand gesture image.

The 3D hand gesture image recognition system in accordance with an aspect of the present invention includes:

a first light field capturing unit provided to capture a hand gesture action to thereby obtain a first 3D hand gesture image;

a calculation unit connected with the first light field capturing unit and provided to project the first 3D hand gesture image to a predetermined space to obtain a first set of first eigenvectors, with further comparing the first eigenvectors with a plurality of samples to classify and recognize a first signal of the first 3D hand gesture image; and

an output unit connected with the calculation unit and provided to output the first signal of the first 3D hand gesture image to a predetermined hand-gesture control device.

In a separate aspect of the present invention, the first 3D hand gesture image includes 2D plane information and depth information.

In a further separate aspect of the present invention, the first 3D hand gesture image is a 3D contour image, a 3D solid RGB image or combination thereof.

In yet a further separate aspect of the present invention, the 3D solid RGB image is further projected to the predetermined space by a projection color space method, thereby obtaining R channel image information, G channel image information and B channel image information.

In yet a further separate aspect of the present invention, the first 3D hand gesture image is projected to the predetermined space by principal component analysis.

In yet a further separate aspect of the present invention, the first eigenvectors are compared with the plurality of samples by a k-nearest neighbor method to classify and recognize the first signal of the first 3D hand gesture image.

In yet a further separate aspect of the present invention, a second light field capturing unit is provided to capture the hand gesture action to thereby obtain a second 3D hand gesture image which is further projected, classified and recognized to obtain a second signal of the second 3D hand gesture image.

In yet a further separate aspect of the present invention, the second signal of the second 3D hand gesture image is identified with the first signal of the first 3D hand gesture image.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a 3D hand gesture image recognition method in accordance with a preferred embodiment of the present invention.

FIG. 2 is a block diagram of a 3D hand gesture image recognition system in accordance with a preferred embodiment of the present invention.

FIGS. 3A and 3B are a series of 3D contour images and 3D solid images captured by the 3D hand gesture image recognition method and system in accordance with the preferred embodiment of the present invention.

FIGS. 4A and 4B are charts illustrating recognition rates in relation to eigenvectors of the 3D contour images and the 3D solid images processed with various in-plane rotation variances by the 3D hand gesture image recognition method and system in accordance with the preferred embodiment of the present invention.

FIGS. 5A and 5B are charts illustrating recognition rates in relation to eigenvectors of the 3D contour images and the 3D solid images processed with various out-of-plane rotation variances by the 3D hand gesture image recognition method and system in accordance with the preferred embodiment of the present invention.

FIG. 6A is a series of 3D solid RGB images captured by the 3D hand gesture image recognition method and system in accordance with the preferred embodiment of the present invention.

FIG. 6B is a series of PCS-projected 3D solid RGB images processed by the 3D hand gesture image recognition method and system in accordance with the preferred embodiment of the present invention.

FIGS. 7(a)-7(e) are a series of an original image, a R-channel image, a G-channel image, a B-channel image and a PCS-projected image processed by the 3D hand gesture image recognition method and system in accordance with the preferred embodiment of the present invention.

FIG. 8 is a chart illustrating recognition rates in relation to eigenvectors of the 3D solid gray-level image and the PCS-projected 3D solid RGB image processed by the 3D hand gesture image recognition method and system in accordance with the preferred embodiment of the present invention.

FIGS. 9(a)-9(f) are a series of an original 3D contour image and five 3D contour images processed with various Gaussian noises by the 3D hand gesture image recognition method and system in accordance with the preferred embodiment of the present invention.

FIG. 10 is a chart illustrating recognition rates in relation to eigenvectors of the 3D contour images processed with various Gaussian noises by the 3D hand gesture image recognition method and system in accordance with the preferred embodiment of the present invention.

FIGS. 11(a)-11(f) are a series of an original 3D solid image and five 3D solid images processed with various Gaussian noises by the 3D hand gesture image recognition method and system in accordance with the preferred embodiment of the present invention.

FIGS. 12(a)-12(f) are a series of an original PCS-projected 3D solid RGB image and five PCS-projected 3D solid RGB images processed with various Gaussian noises by the 3D hand gesture image recognition method and system in accordance with the preferred embodiment of the present invention.

FIG. 13 is a chart illustrating recognition rates in relation to eigenvectors of the 3D contour images processed with various Gaussian noises by the 3D hand gesture image recognition method and system in accordance with the preferred embodiment of the present invention.

### DETAILED DESCRIPTION OF THE INVENTION

It is noted that a 3D hand gesture image recognition method and system thereof in accordance with the preferred embodiment of the present invention can be applicable to various apparatus, including computer systems, electric appliance control systems (e.g. IoT (Internet of things)), automatic control systems, medical service systems or security systems, which are not limitative of the present invention.

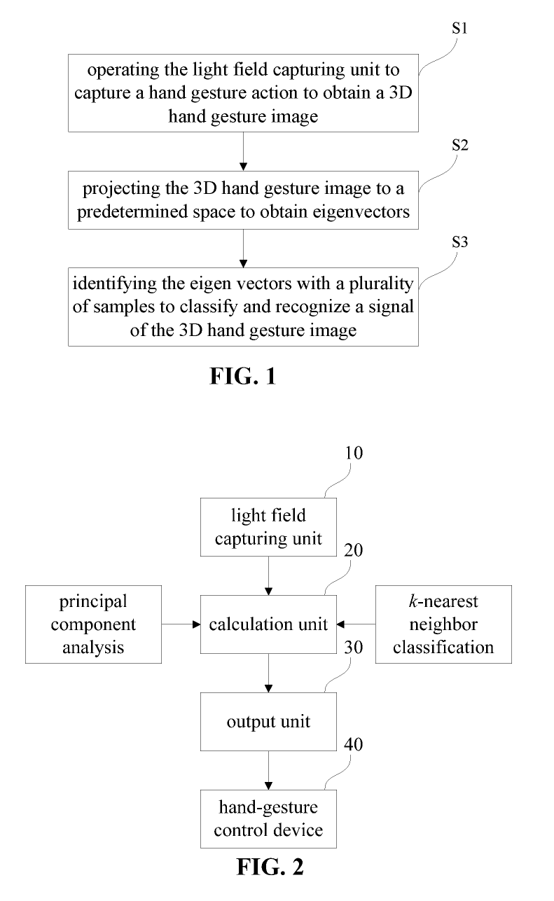

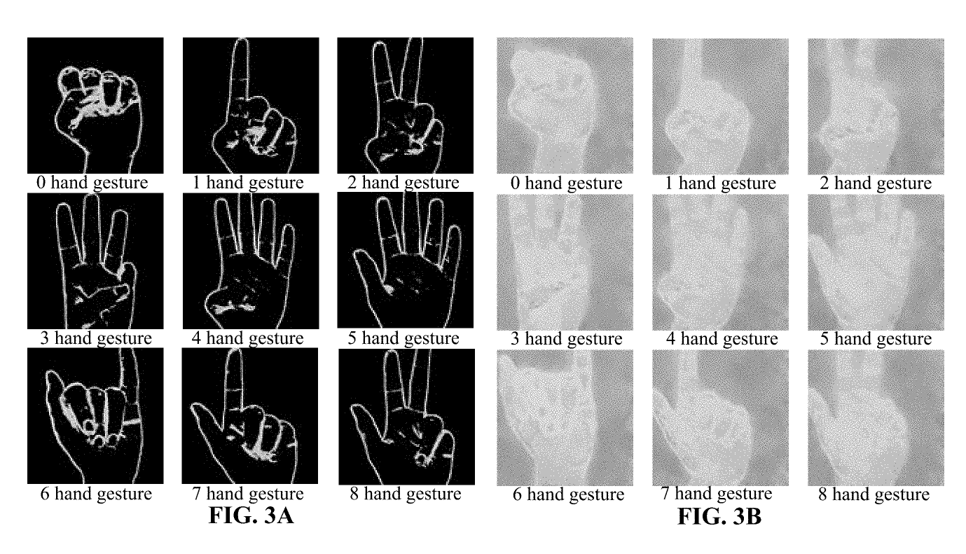

FIG. 1 shows a block diagram of a 3D hand gesture image recognition method in accordance with a preferred embodiment of the present invention and FIG. 2 further shows a block diagram of a 3D hand gesture image recognition system in accordance with a preferred embodiment of the present invention. Referring now to FIGS. 1 and 2, the 3D hand gesture image recognition system in accordance with the preferred embodiment of the present invention includes a light field capturing unit 10, a calculation unit 20 and an output unit 30, with the calculation unit 20 connecting with the light field capturing unit 10, with the output unit 30 connecting with the calculation unit 20, with the output unit 30 connecting with a predetermined hand-gesture control device 40.

With continued reference to FIGS. 1 and 2, the 3D hand gesture image recognition method in accordance with the preferred embodiment of the present invention includes the step S1: operating the light field capturing unit 10 to capture a hand gesture action to thereby obtain at least one first 3D hand gesture image. By way of example, the first 3D hand gesture image includes 2D plane information and depth information separately captured by first and second units of the light field capturing unit 10. In a preferred embodiment, the first 3D hand gesture image is a 3D contour image, a 3D solid gray-level image, a 3D solid RGB image or combination thereof.

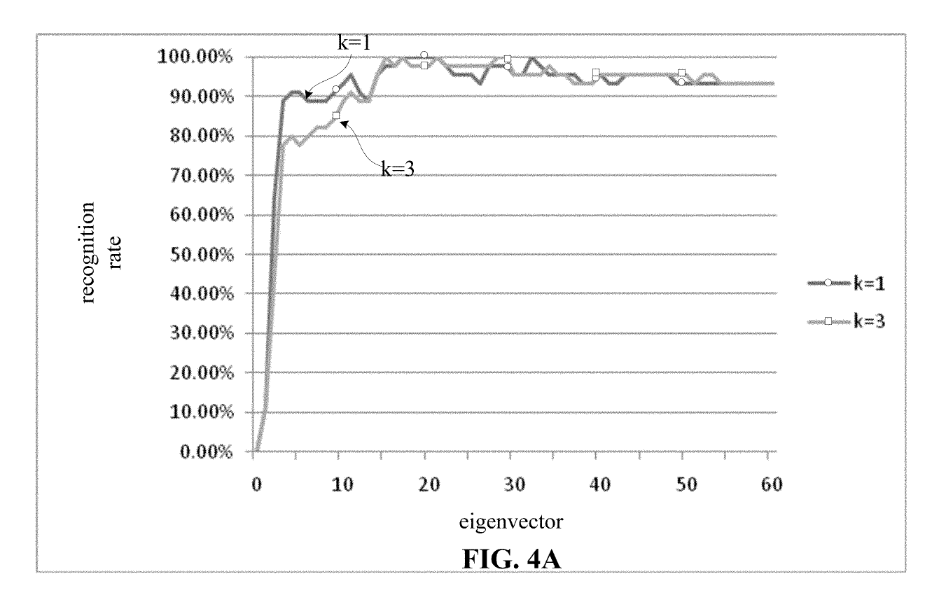

FIG. 3A shows a series of 3D contour images of 0 to 8 hand gestures (or other numbers) captured by the 3D hand gesture image recognition method and system in accordance with the preferred embodiment of the present invention. FIG. 3B shows a series of 3D solid RGB images of 0 to 8 hand gestures, corresponding those shown in FIG. 3A, captured by the 3D hand gesture image recognition method and system in accordance with the preferred embodiment of the present invention.

Referring again to FIGS. 1 and 2, the 3D hand gesture image recognition method in accordance with the preferred embodiment of the present invention further includes the step S2: operating the calculation unit 20 to project the first 3D hand gesture image to a predetermined space to obtain at least one set of eigenvectors. By way of example, the calculation unit 20 can project the first 3D hand gesture image to the predetermined space with a principal component analysis (PCA) method for recognizing the first 3D hand gesture image.

In order to retain a degree of data variance, the PCA method is applied to reduce dimensions of high-dimensional data. However, 1D PCA method can convert dimensions of training images into linear dimensions. By way of example, in calculating covariance matrixes, a (m×n) sized image will be calculated to generate a (m×n)×(m×n) matrix which will require a great time for calculating eigenvectors. Accordingly, the original covariance matrix can be reduced to the form

$${C}_{i} = \frac{1}{L} {\sum }_{tr = 1}^{L} {( {X}_{tr} - \overline{X} )}^{T} ( {X}_{tr} - \overline{X} )$$

where Cᵢ is a reduced covariance matrix, L is a number of training samples, Xₜᵣ is a training image and X̅ is an average of total training images. Advantageously, dimensions of the original covariance matrix can be reduced to the size of matrix L×L which will reduce the calculation time for projecting the 3D hand gesture image to a basis. Furthermore, a singular value decomposition (SVD) method is applied to further calculate the reduced covariance matrix in the form

Cᵢ=UᵢΣᵢVᵢ^{T}

where Uᵢ and Vᵢ are orthogonal matrixes and Σᵢ is an eigenvalue matrix of SVD.

The eigenvalue matrix Σᵢ is same with a SVD eigenvalue matrix Σ decomposed from the original covariance matrix C. The eigenvector matrix U is calculated from (Xₜᵣ−X̅)*Uᵢ. Subsequently, the eigenvector matrix is applied to project the original training data to a PCA space to obtain PCA-processed eigenvector Fₜᵣ of training samples.

Referring again to FIGS. 1 and 2, the 3D hand gesture image recognition method in accordance with the preferred embodiment of the present invention further includes the step S3: operating the calculation unit 20 to compare the eigenvectors with a plurality of samples to classify and recognize a signal of the 3D hand gesture image. By way of example, the calculation unit 20 can be compared and classified by a k-nearest neighbors (KNN) method which calculates k nearest training sample images in an eigenspace to project a test image to the PCA space and to further compare them with the training samples for calculating similarity. A similarity matrix can be calculated in the form

$${S}_{k} = {\sum }_{n = 1}^{N} \vert {F}_{te} - {F}_{tr} \vert$$

where Sₖ is a similarity matrix, k is a preset number of nearest neighbor training samples, N is a maximum of eigenvectors, Fₜₑ is an eigenvector of test samples and Fₜᵣ is an eigenvector of training samples. According to k value, a set of k nearest similarity training samples is selected to judge the test data nearly similar to which signal type of the predetermined training samples for predicting hand gesture classification.

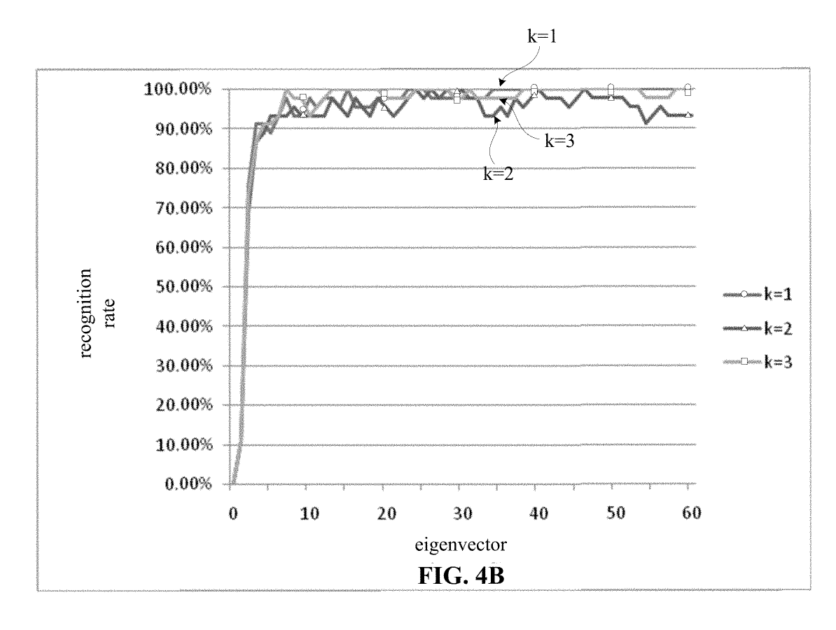

FIG. 4A shows a chart illustrating recognition rates in relation to eigenvectors of the 3D contour images processed with various in-plane rotation variances by the 3D hand gesture image recognition method and system in accordance with the preferred embodiment of the present invention. Referring to FIG. 4A, rotational angles applied in the preferred embodiment of the present invention are ±3, ±5, ±8 and ±10. A maximum of recognition rate of the 3D contour image is 100% if k=1 and k=3 and the k=1 recognition rate more rapidly increases to 100% than the k=3 recognition rate when the eigenvector increases. All of the recognition rates occurs slight deterioration when the eigenvector further increases.

FIG. 4B shows a chart illustrating recognition rates in relation to eigenvectors of the 3D solid images processed with various in-plane rotation variances by the 3D hand gesture image recognition method and system in accordance with the preferred embodiment of the present invention. Referring to FIG. 4B, rotational angles applied in the preferred embodiment of the present invention are ±3, ±5, ±8 and ±10. A recognition rate of the 3D solid image is obviously fluctuating if k=2 with respect to k=1 and k=3. A maximum of recognition rate of the 3D solid image is 100% if k=3 and suitable recognition. All of the recognition rates occurs slight deterioration when the eigenvector further increases.

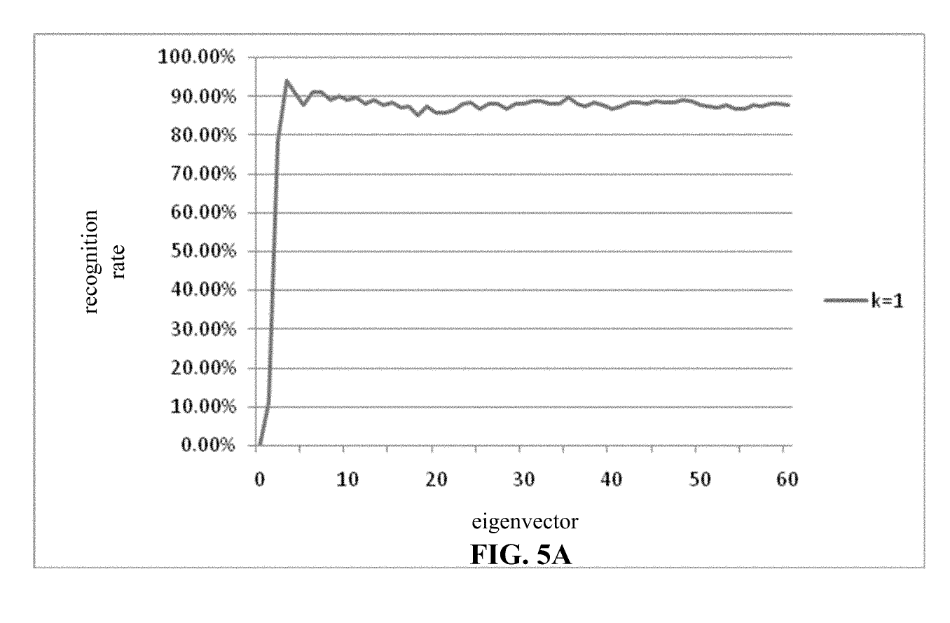

FIG. 5A shows a chart illustrating recognition rates in relation to eigenvectors of the 3D contour images processed with various out-of-plane rotation variances by the 3D hand gesture image recognition method and system in accordance with the preferred embodiment of the present invention. Referring to FIG. 5A, rotational angles applied in the preferred embodiment are ±15 and ±30. A maximum of recognition rate of the 3D contour image is 94.07% if k=1 and the recognition rate occurs slight deterioration when the eigenvector further increases.

FIG. 5B shows a chart illustrating recognition rates in relation to eigenvectors of the 3D solid gray-level images processed with various out-of-plane rotation variances by the 3D hand gesture image recognition method and system in accordance with the preferred embodiment of the present invention. Referring to FIG. 5B, rotational angles applied in the preferred embodiment are ±15 and ±30. A maximum of recognition rate of the 3D solid gray-level image is 78.89% if k=1 and the recognition rate occurs slight deterioration when the eigenvector further increases.

In another embodiment, in order to retain complete depth information of the 3D solid RGB image, the 3D solid RGB image is further projected to the predetermined space by a projection color space (PCS) method, thereby obtaining R channel image information, G channel image information and B channel image information.

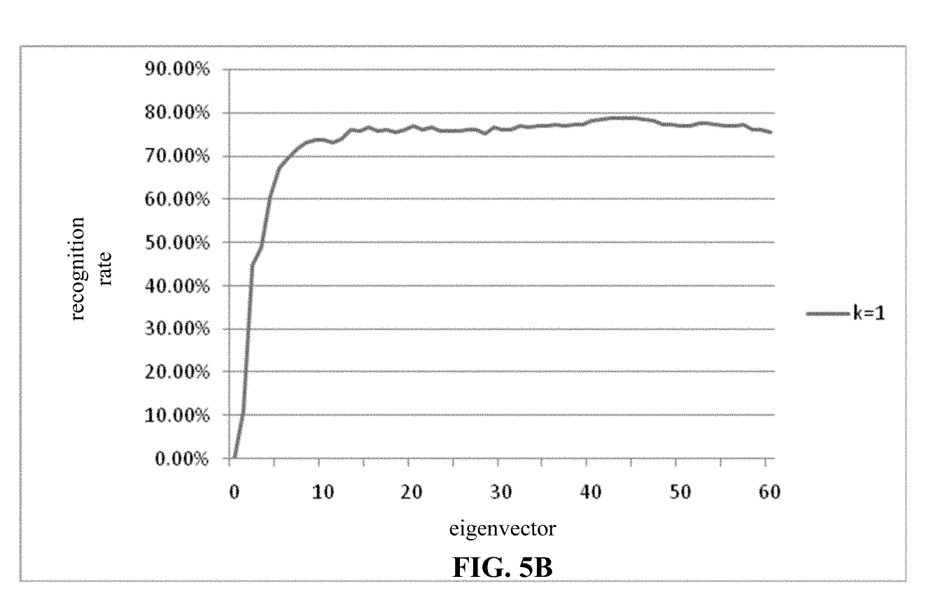

FIG. 6A shows a series of 3D solid RGB images captured by the 3D hand gesture image recognition method and system in accordance with the preferred embodiment of the present invention. FIG. 6B shows a series of 3D solid RGB images, as shown in FIG. 6A, projected with the PCS method processed by the 3D hand gesture image recognition method and system in accordance with the preferred embodiment of the present invention.

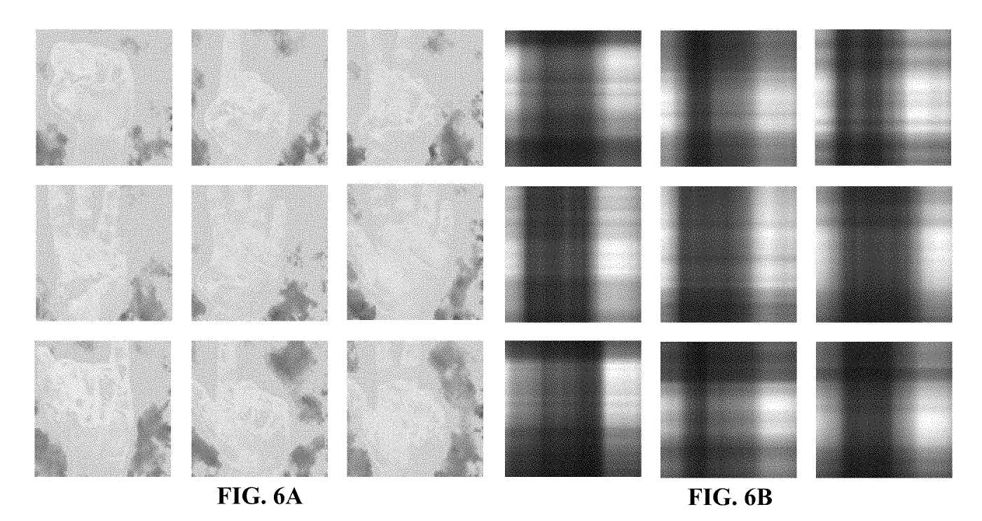

FIGS. 7(a)-7(e) show a series of an original image, a R-channel image, a G-channel image, a B-channel image and a PCS-projected image processed by the 3D hand gesture image recognition method and system in accordance with the preferred embodiment of the present invention. Referring to FIGS. 7(a)-7(e), the original 3D solid RGB image is extracted, as shown in FIG. 7(a), and processed with the PCS method to generate the R-channel solid image, the G-channel solid image and the B-channel solid image, as shown in FIGS. 7(b), 7(c) and 7(d), to obtain separate RGB channel information which is further projected to the same space to obtain the PCS-projected solid image, as shown in FIG. 7(e).

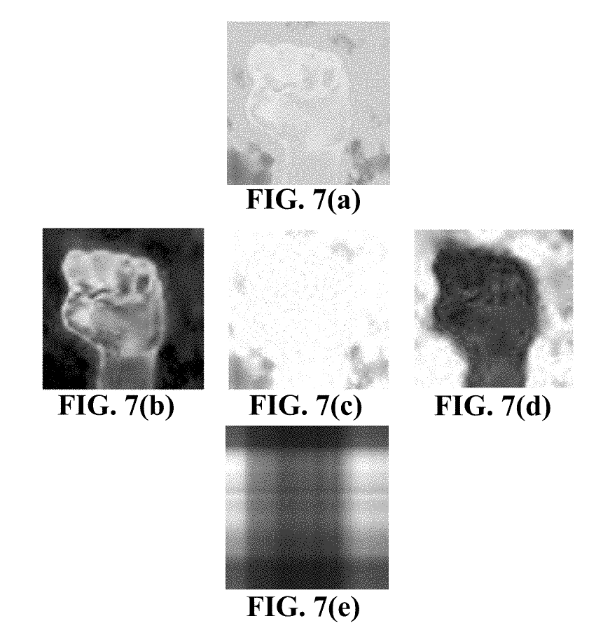

FIG. 8 shows a chart illustrating recognition rates in relation to eigenvectors of the 3D solid gray-level image and the PCS-projected 3D solid RGB image processed by the 3D hand gesture image recognition method and system in accordance with the preferred embodiment of the present invention. Referring to FIG. 8, a maximum of recognition rate of the PCS-projected 3D solid RGB image reaches 96.67% at its 14th root of eigenvectors which retain R channel image information, G channel image information and B channel image information. However, the recognition rate of the PCS-projected 3D solid RGB image is obviously higher than that of the 3D solid gray-level image.

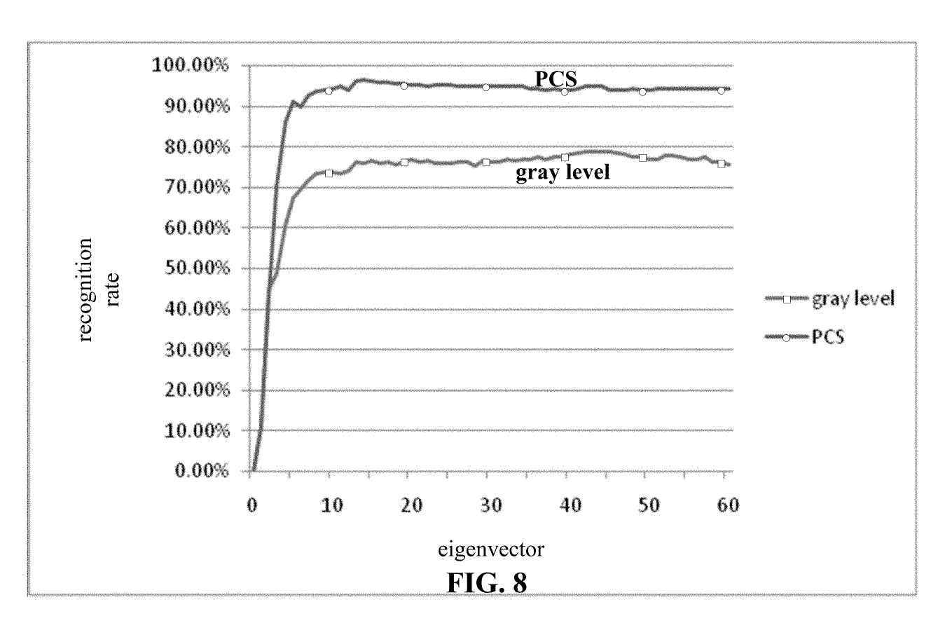

FIGS. 9(a)-9(f) show a series of an original 3D contour image and five 3D contour images processed with various Gaussian noises by the 3D hand gesture image recognition method and system in accordance with the preferred embodiment of the present invention. Referring to FIGS. 9(a)-9(f), no Gaussian noise is added in the original 3D contour image, as shown in FIG. 9(a), and 1%, 5%, 10%, 20% and 30% Gaussian noises as variance conditions are added in the original 3D contour image, respectively, to generate five noise-added 3D contour images, as shown in FIGS. 9(b)-9(f).

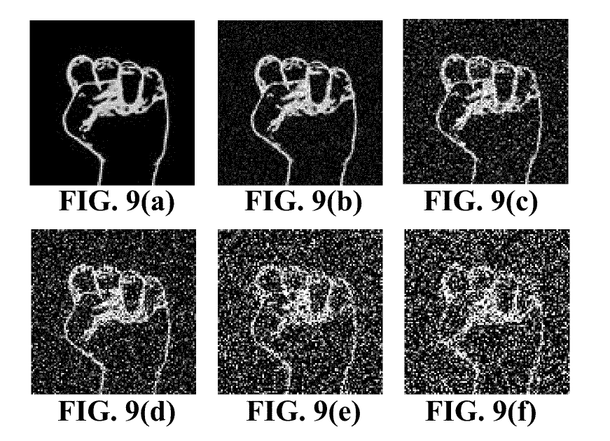

FIG. 10 shows a chart illustrating recognition rates in relation to eigenvectors of the 3D contour images processed with various Gaussian noises by the 3D hand gesture image recognition method and system in accordance with the preferred embodiment of the present invention. Referring to FIG. 10, a maximum of recognition rate is still higher than 90% when at most 5% Gaussian noise is added. The maximum of recognition rate may be slightly lower when the added Gaussian noise increases to 10% and reaches 82.22% when the added Gaussian noise increases to 30%.

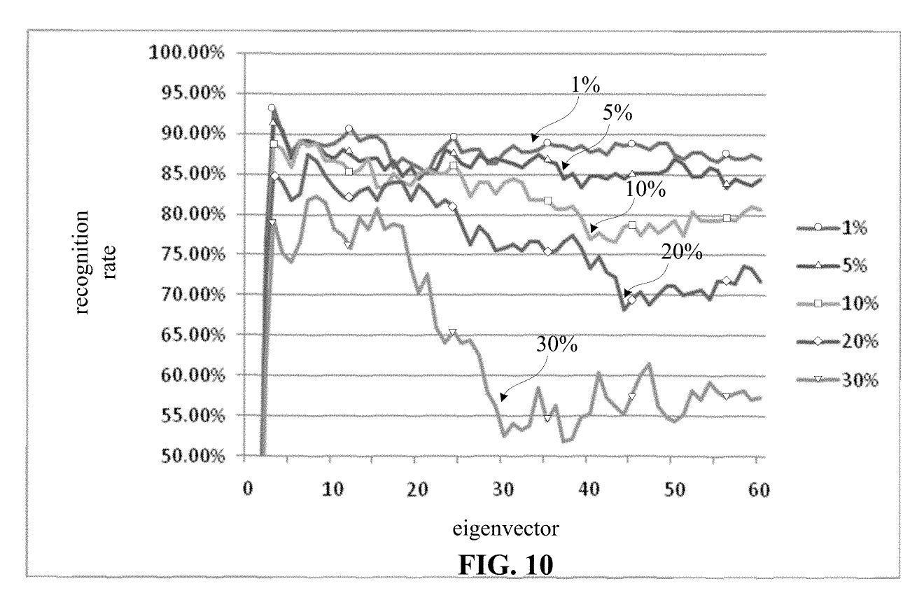

FIGS. 11(a)-11(f) show a series of an original 3D solid image and five 3D solid images processed with various Gaussian noises by the 3D hand gesture image recognition method and system in accordance with the preferred embodiment of the present invention. FIGS. 11(a)-11(f), no Gaussian noise is added in the original 3D solid image, as shown in FIG. 11(a), and 1%, 5%, 10%, 20% and 30% Gaussian noises as variance conditions are added in the original 3D solid image, respectively, to generate five noise-added 3D solid images, as shown in FIGS. 11(b)-11(f).

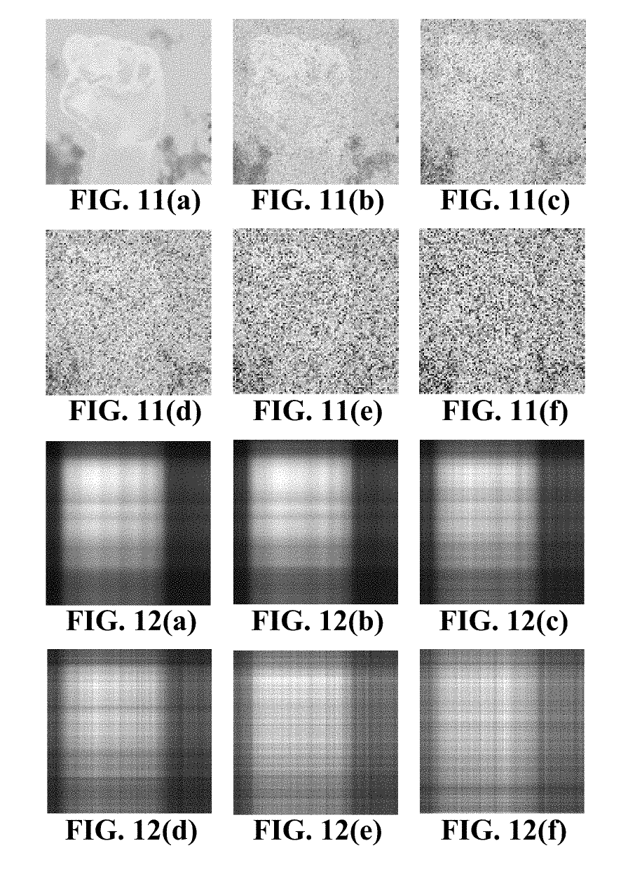

FIGS. 12(a)-12(f) show a series of an original PCS-projected 3D solid RGB image and five PCS-projected 3D solid RGB images processed with various Gaussian noises by the 3D hand gesture image recognition method and system in accordance with the preferred embodiment of the present invention. Referring to FIGS. 11(a)-11(f) and 12(a)-12(f), the original 3D solid image and five noise-added 3D solid images, as shown in FIGS. 11(a)-11(f), are further projected to obtain the original PCS-projected 3D solid RGB image and five PCS-projected 3D solid RGB images for recognition, as shown in FIGS. 12(a)-12(f).

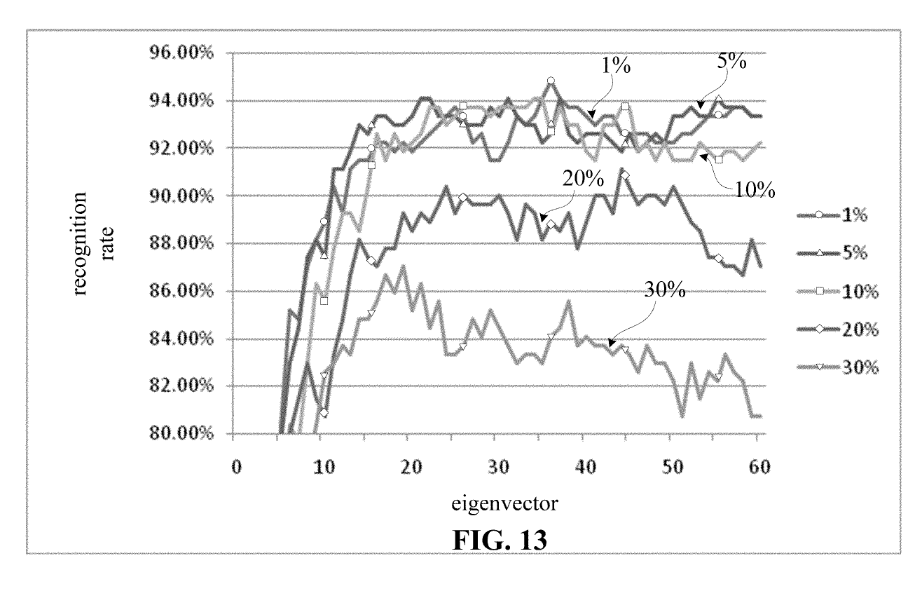

FIG. 13 shows a chart illustrating recognition rates in relation to eigenvectors of the 3D contour images processed with various Gaussian noises by the 3D hand gesture image recognition method and system in accordance with the preferred embodiment of the present invention. Referring to FIG. 13, a maximum of recognition rate is still higher than 85% even though 30% Gaussian noise is added.

Referring back to FIGS. 1 and 2, the 3D hand gesture image recognition method in accordance with the preferred embodiment further includes: operating the light field capturing unit 10 to obtain another 3D hand gesture image and another signal and identifying with the previous signal.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A 3D hand gesture image recognition method comprising:
operating a light field capturing unit to capture a hand gesture action to thereby obtain at least one 3D hand gesture image;
projecting the at least one 3D hand gesture image to a predetermined space to obtain at least one set of eigenvectors; and
comparing the eigenvectors with a plurality of samples to classify and recognize a signal of the 3D hand gesture image.

2. The method as defined in claim 1, wherein the 3D hand gesture image includes 2D plane information and depth information.

3. The method as defined in claim 1, wherein the 3D hand gesture image is a 3D contour image, a 3D solid RGB image or combination thereof.

4. The method as defined in claim 3, wherein the 3D solid RGB image is further projected to the predetermined space by a projection color space method, thereby obtaining R channel image information, G channel image information and B channel image information.

5. The method as defined in claim 1, wherein the 3D hand gesture image is projected to the predetermined space by principal component analysis.

6. The method as defined in claim 1, wherein the eigenvectors are compared with the plurality of samples by a k-nearest neighbor method to classify and recognize the signal of the 3D hand gesture image.

7. A 3D hand gesture image recognition method comprising:
operating a light field capturing unit to capture a series of hand gesture actions to thereby obtain a first 3D hand gesture image and a second 3D hand gesture image;
projecting the first 3D hand gesture image and the second 3D hand gesture image to a predetermined space to obtain a first set of first eigenvectors and a second set of second eigenvectors;
comparing the first eigenvectors and the second eigenvectors with a plurality of samples to classify and recognize a first signal of the first 3D hand gesture image and a second signal of the second 3D hand gesture image; and
identifying the second signal of the second 3D hand gesture image with the first signal of the first 3D hand gesture image.

8. The method as defined in claim 7, wherein the first 3D hand gesture image and the second 3D hand gesture image include 2D plane information and depth information.

9. The method as defined in claim 7, wherein the first 3D hand gesture image and the second 3D hand gesture image are 3D contour images, 3D solid RGB images or combination thereof.

10. The method as defined in claim 9, wherein the 3D solid RGB image is further projected to the predetermined space by a projection color space method, thereby obtaining R channel image information, G channel image information and B channel image information.

11. The method as defined in claim 7, wherein the first 3D hand gesture image and the second 3D hand gesture image are projected to the predetermined space by principal component analysis.

12. The method as defined in claim 7, wherein the first eigenvectors and the second eigenvectors are compared with the plurality of samples by a k-nearest neighbor method to classify and recognize the signal of the 3D hand gesture image.

13. A 3D hand gesture image recognition system comprising:
a first light field capturing unit provided to capture a hand gesture action to thereby obtain a first 3D hand gesture image;
a calculation unit connected with the first light field capturing unit and provided to project the first 3D hand gesture image to a predetermined space to obtain a first set of first eigenvectors, with further comparing the first eigenvectors with a plurality of samples to classify and recognize a first signal of the first 3D hand gesture image; and
an output unit connected with the calculation unit and provided to output the first signal of the first 3D hand gesture image to a predetermined device.

14. The system as defined in claim 13, wherein the first 3D hand gesture image includes 2D plane information and depth information.

15. The system as defined in claim 13, wherein the first 3D hand gesture image is a 3D contour image, a 3D solid RGB image or combination thereof.

16. The system as defined in claim 15, wherein the 3D solid RGB image is further projected to the predetermined space by a projection color space method to obtain R channel image information, G channel image information and B channel image information.

17. The system as defined in claim 13, wherein the first 3D hand gesture image is projected to the predetermined space by principal component analysis.

18. The system as defined in claim 13, wherein the first eigenvectors are compared with the plurality of samples by a k-nearest neighbor method to classify and recognize the first signal of the first 3D hand gesture image.

19. The system as defined in claim 13, wherein a second light field capturing unit is provided to capture the hand gesture action to thereby obtain a second 3D hand gesture image which is further projected, classified and recognized to obtain a second signal of the second 3D hand gesture image.

20. The system as defined in claim 19, wherein the second signal of the second 3D hand gesture image is identified with the first signal of the first 3D hand gesture image.
